(19) United States
(12) Patent Application Publication
(10) Pub. No.: US 2011/0320940 A1
(43) Pub. Date: Dec. 29, 2011

(54) ELECTRONIC DEVICE AND METHOD OF SWITCHING WORKING MODES

(75) Inventor: TENG-YU TSAI, Tu-Cheng (TW)

(73) Assignee: HON HAI PRECISION INDUSTRY CO., LTD., Tu-Cheng (TW)

(21) Appl. No.: 12/947,737

(22) Filed: Nov. 16, 2010

(30) Foreign Application Priority Data
Jun. 23, 2010 (CN) 201010207199.7

(51) Int. Cl. G06F 3/01

(52) U.S. Cl. 715/702

(57) ABSTRACT

An electronic device includes a touch screen, a user interface module, a detecting module and a process module. The user interface module is configured to create a user interface on the touch screen. A number of hidden active areas are defined in the user interface. A detecting module is configured to detect if the hidden active areas are touched and in what order. A process module is configured to switch the user interface from an operation mode to a test mode after the hidden active areas are touched in a predetermined sequence.

### BACKGROUND

1. Technical Field

The present disclosure relates to electronic devices, and particularly to an electronic device and a method of switching working modes of the electronic device.

2. Description of Related Art

A test mode or engineering mode is a mode, usually hidden, inserted into consumer electronic devices, such as mobile phone, by the manufacturers. They are generally intended to be used by authorized maintenance people. Test modes usually include functions such as displaying test card images and testing moving parts. The test mode is generally useless to a general consumer who does not know anything about how the device works. However, some electronic devices may have menus to allow the end user to enter the test mode to change some functions which may affect basic usability of the electronic devices.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an electronic device in accordance with an embodiment.

FIG. 2 illustrates a user interface of an electronic device in one embodiment.

FIG. 3 is a flowchart of a method of switching modes in the electronic device in one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

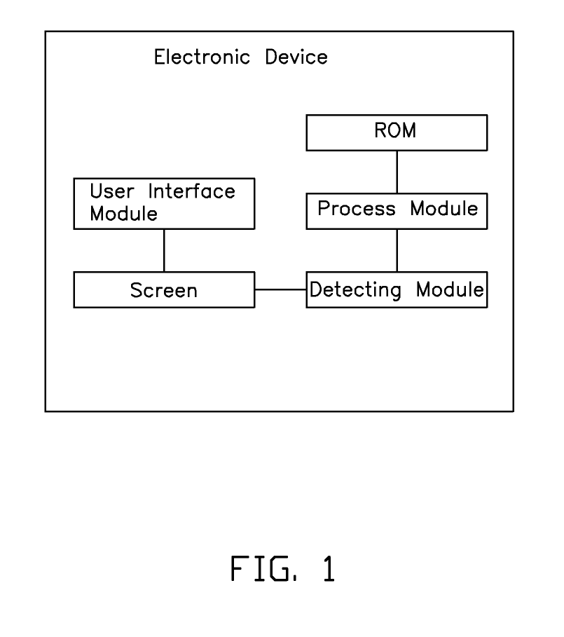

Referring to FIG. 1, in one embodiment, an electronic device may include a process module, a ROM, a detecting module, a user interface module, and a screen.

The electronic device may be an embedded electronic device, such as a digital photo frame, a media player, or a mobile phone, etc. In one embodiment, the electronic device is printer.

The screen may be a touch screen. The touch screen is an electronic visual display that can detect the presence and location of a touch within the display area. The touch screen can recognize a touch on a restricted area, such as a point of the screen; or a sliding touch taking in more than one area or point. The touch can be performed with a finger or a stylus.

The user interface module may be a firmware or a software program stored in a storage device. The user interface module can create a user interface on the touch screen when executed by the process module. A plurality of hidden active areas is defined in the user interface.

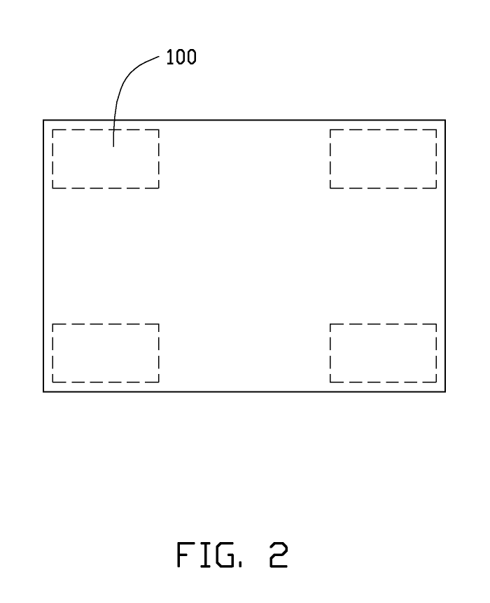

Referring to FIG. 2, in one embodiment, the user interface is rectangular. The plurality of hidden active areas includes four hidden active areas 100. The four hidden active areas 100 are located in four corners of the user interface.

The detecting module can detect if the four hidden active areas 100 are touched in a predetermined sequence. The detecting module is further capable of determining if a touch on the touch screen is a point touch or a sliding touch by measuring distance between the beginning of the touch and the release. If the measured distance is shorter than a predetermined distance then the touch is taken as a point touch. The predetermined sequence can be defined and modified as desired or needed for the specific application environment.

The process module is capable of switching the user interface from an operation mode to a test mode after the hidden active areas 100 are touched in the predetermined sequence. In the operation mode, common functions of the electronic device are operable by the user. In the test mode, some professional configurations of the electronic device are operable by the user.

Referring to FIG. 2, in one embodiment, the process module is capable of switching the user interface from the working mode to the test mode after the four hidden active areas 100 are touched in a clockwise or anticlockwise direction in sequence. When the four hidden active areas 100 are touched in the clockwise, the hidden active areas 100 are sequentially touched in the following order: top left, top right, bottom right, and then bottom left; when the four hidden active areas 100 are touched in the anticlockwise, the hidden active areas 100 are sequentially touched in the following order: bottom left, bottom right, top right and then top left.

In other embodiments, other predetermined sequences can be used, for example, the process module is capable of switching the user interface from the working mode to the test mode after the hidden active areas 100 are sequentially touched in another following order: top left, bottom right, bottom left, and then top right.

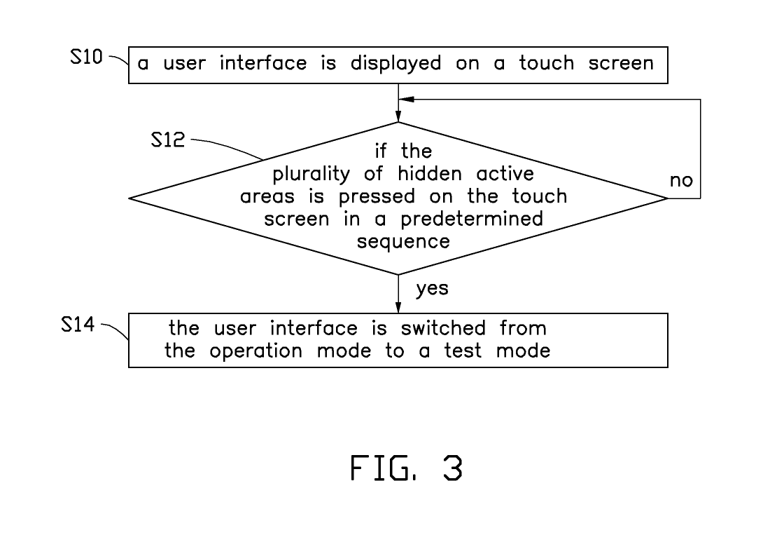

Referring to FIG. 3, one embodiment of a method of switching working modes of an electronic device includes the following blocks.

In block S10, a user interface is displayed on a touch screen. The electronic device is in an operation mode.

In block S12, if the hidden active areas are pressed in a predetermined sequence, go to block S14. In detail, the detecting module is capable of detecting if the hidden active areas are point touched and in what order as detailed above.

In block S14, the user interface is switched from the operation mode to a test mode.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is also to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An electronic device comprising:
a touch screen;
a user interface module, the user interface module configured to create a user interface on the touch screen, and a plurality of hidden active areas defined in the user interface;
a detecting module configured to detect if the plurality of hidden active areas is touched in a predetermined sequence; and
a process module configured to switch the user interface from an operation mode to a test mode after the plurality of hidden active areas is touched in the predetermined sequence.

2. The electronic device of claim 1, wherein the detecting module is configured to detect if the plurality of hidden active areas is point touched.

3. The electronic device of claim 2, wherein the detecting module is configured to detect if the plurality of hidden active areas is point touched by measuring a movement distance of a touch on each of the plurality of hidden active areas, and if the movement distance is shorter than a predetermined distance, the touch is point touch.

4. The electronic device of claim 1, wherein the user interface is rectangular, and the plurality of hidden active areas comprises four hidden active areas, and the four hidden active areas are located in four corners of the user interface.

5. The electronic device of claim 4, wherein the process module is configured to switch the user interface from the operation mode to the test mode after the four hidden active areas are touched along a clockwise direction in sequence.

6. The electronic device of claim 1, wherein the electronic device is a printer.

7. A method of switching working modes of an electronic device, the method comprising:
displaying a user interface on a touch screen, wherein a plurality of hidden active areas is defined in the user interface;
detecting if the plurality of hidden active areas is touched in a predetermined sequence; and
switching the user interface from an operation mode to a test mode.

8. The method of claim 7, wherein detecting if the plurality of hidden active areas is touched on the touch screen further comprises determining if the plurality of hidden active areas is point touched.

9. The method of claim 8, wherein detecting if the plurality of hidden active areas is point touched comprises obtaining a movement distance of a touch on each of the plurality of hidden active areas, and if the movement distance is shorter than a predetermined distance, the plurality of hidden active areas is point touched.

10. The method of claim 7, wherein the user interface is rectangular, and the plurality of hidden active areas comprises four hidden active areas, and the four hidden active areas are located in four corners of the user interface.

11. The method of claim 10, wherein detecting if the plurality of hidden active areas is touched in a predetermined sequence further comprises determining if the plurality of hidden active areas is touched along a clockwise direction.

12. The method of claim 7, wherein the electronic device is a printer.

13. A method of switching working modes of an electronic device, the method comprising:
providing a touch screen; a user interface module, the user interface module configured to create a user interface on the touch screen and a plurality of hidden active areas defined in the user interface; a detecting module configured to detect if the plurality of hidden active areas is touched in a predetermined sequence; and a process module configured to switch the user interface from an operation mode to a test mode after the plurality of hidden active areas is touched in the predetermined sequence;
displaying a user interface on a touch screen;
detecting if the plurality of hidden active areas is touched in a predetermined sequence; and
switching the user interface from an operation mode to a test mode.
